(19) United States
(12) Patent Application Publication
(10) Pub. No.: US 2025/0273090 A1
(43) Pub. Date: Aug. 28, 2025

(54) Tactile Displaying Method Utilizing Small Motors

(71) Applicant: Yash MEHTA, Morrisville, NC (US)

(72) Inventor: Yash MEHTA, Morrisville, NC (US)

(21) Appl. No.: 19/060,737

(22) Filed: Feb. 23, 2025

Related U.S. Application Data
(60) Provisional application No. 63/557,479, filed on Feb. 24, 2024.

(51) Int. Cl. G09B 21/00

(52) U.S. Cl. CPC G09B 21/003

(57) ABSTRACT

The present invention discloses a novel, affordable, and durable display for visually impaired individuals. Unlike traditional Braille displays which rely on expensive and complex piezoelectric modules, this invention utilizes readily available and inexpensive small motors to provide stimulation from rotating shafts to represent Braille characters. A programmable system that controls the operation of motors is used to control motors. This significantly reduces the cost of the device, making it accessible to a wider range of users. Additionally, the design offers improved durability and faster response times compared to conventional solutions.

### CROSS-REFERENCE TO RELATED APPLICATIONS

The present application claims priority from U.S. Provisional Patent Application No. 63/557,479, filed Feb. 24, 2024, the disclosures of which are hereby incorporated herein by reference in their entireties.

### BACKGROUND OF THE INVENTION

Braille is a critical tool for literacy and learning among individuals with visual impairments. Despite its importance, access to Braille materials is often limited due to the high cost of Braille books and electronic displays. Refreshable Braille Displays (RBDs) have been developed to provide these individuals with access to electronic text and information. However, these devices are often prohibitively expensive.

Various technologies have been employed in the design of RBDs. These include:
1. Piezoelectric: This technology uses crystals that expand and contract to raise and lower pins, forming Braille characters. While it offers fast refresh rates, it tends to be noisy and bulky.
2. Electromagnetic: This approach uses tiny magnets to move pins or membranes to create Braille dots. It is quiet and compact but suffers from limited refresh rates and high-power consumption.
3. Shape Memory Alloy (SMA): SMA wires contract or expand with heat, actuating Braille pins. This technology is durable and low power, but it has slower refresh rates.
4. Microelectromechanical Systems (MEMS): MEMS use miniaturized mechanisms to move Braille pins with high precision. They offer high resolution and potential for customization, but they are still under development.

Despite the advancements in these technologies, several challenges persist in the field of RBDs:
Cost: The high cost of many RBDs limits their accessibility.
Refresh Rate: Faster refresh rates are needed for dynamic content like web browsing.
Durability: The pins in these devices can wear out or break, necessitating repairs.
Size and Weight: There is a preference for devices that are smaller and lighter to enhance portability.
Power Consumption: Low power consumption is crucial for extending battery life.
Customization: There are limited options for different pin heights, spacing, and Braille standards.

These challenges underscore the need for further innovation in the design and development of RBDs.

### SUMMARY OF THE INVENTION

This invention introduces a novel Braille or Tactile display design that utilizes coreless motors to overcome current limitations. The key features of this design are organized as follows:
1. Coreless Motors Configuration:
   Each Braille or Tactile cell comprises six coreless motors arranged in a 3×2 configuration.
   Each motor's shaft represents a single Braille or Tactile dot, rotating to create a sensation at the position of the Braille or Tactile dot, thereby creating Braille characters.
2. Motor Shaft Enhancements:
   The motors can be tilted at an angle such that the shafts provide greater contact surface to the touch. The adjacent shafts can be rotated in opposite directions (clockwise and anti-clockwise) to enhance accuracy. The shafts can be coated with materials that provide friction with the touch surface of the finger to improve recognition of moving shafts. One such material is silicone that can be coated onto the shafts pretreated with chemicals that lead to bonding between silicone and steel (e.g., IMB adhesives from Lord). Shafts can also be pitted, made rough, or attached to another element that spins along with the shaft to improve recognition.
3. User Customization:
   The distance between the motor shafts can be optimized for individual user preferences and touch sensitivity. Data shows that increasing the distance between the shafts leads to better recognition when they are further apart.
4. Vibration Pattern:
   Vibrating motors can be used to generate vibration patterns. Each motor can be isolated so that vibration from one motor does not interfere with the vibration of a different motor. The rotation speed of the motor can also be optimized for optimal sensation and accuracy.
5. Display Extension:
   The display can be extended from a traditional 2×3 Braille cell pattern, to display images, lines, or 2D patterns. This can enhance the learning of visually impaired individuals who can place their whole hand to feel the lines or images that are displayed by this device.
6. Programmable Microcontroller:
   The motors are connected to a programmable microcontroller (e.g., Arduino Uno, Raspberry Pi) via a motor driver. The microcontroller is programmed to receive text data from a computer or smartphone or other electronic means to turn on or off the motors, driving individual motors to correspond to the desired Braille pattern. The refresh rate between characters on the Braille cell can be adjusted either via a voice input that provides a microphone signal to the microcontroller or via a sensor (e.g., a pressure sensor that increases or decreases the refresh rate based on pressure applied by another finger). Another way to change the refresh rate is through a potentiometer in which the user can turn the potentiometer to increase or reduce the refresh rate. The data from other devices (e.g., computer or smartphone) can be transmitted via a cable, Bluetooth, or Wi-Fi.
7. Reading Speed and Power Consumption:
   An average Braille reading speed is about 7.5 characters per second. This translates to about a 130 ms refreshable rate. When the ends of motor shafts were 4 mm apart, refreshable rates as fast as 50 ms led to fairly accurate recognition (>90% accuracy). These coreless motors have low power consumption. During their operation, the power consumption per motor was less than 300 mwatts.

Compared to traditional displays, the use of coreless motors significantly reduces the overall cost of the device, making it more accessible to users. Unlike electromechanical modules used in conventional displays, coreless motors exhibit greater durability and are less prone to breakdowns. The sensation produced via the rotation of motor shafts delivers faster response times compared to electromagnet-based methods.

### BRIEF DESCRIPTION OF DRAWINGS

FIG. 1 shows an example of a 2×3 braille cell with vertically placed motors.

FIG. 2 illustrates an example of a 2×3 braille cell where motors are positioned at an angle. It also demonstrates how the adjacent shafts on the motor can be programmed to rotate either clockwise or anticlockwise.

FIG. 3 presents an example of a microcontroller controlling the motors based on letter inputs from a computer or smartphone, with the refresh rate controlled by an external module that the user can manipulate.

FIG. 4 shows an Arduino program that controls an Arduino board to drive motors based on the text input. The refresh rate is controlled by a potentiometer, which is a type of variable resistor.

### DETAILED DESCRIPTION OF THE INVENTION

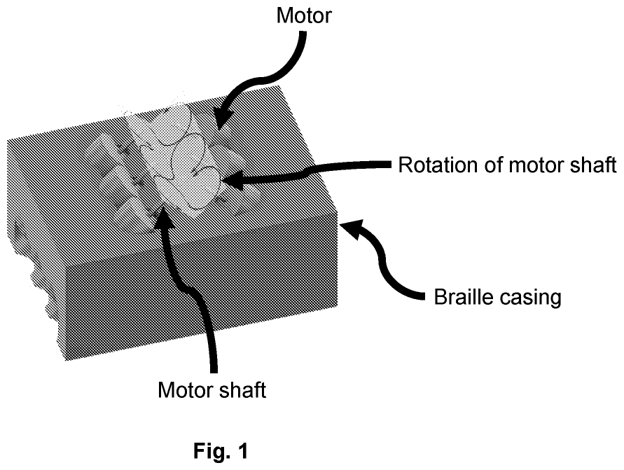

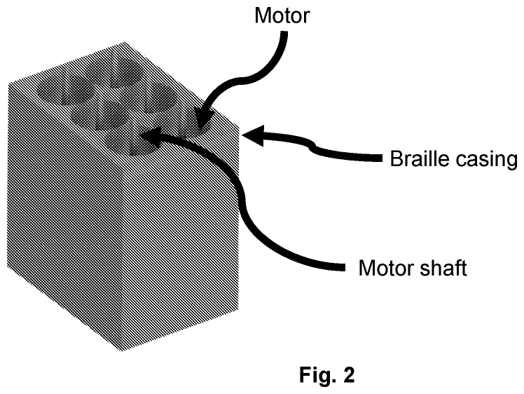

The present invention addresses the current limitations by introducing a novel Braille or tactile display design utilizing coreless motors. In one of the embodiments, each Braille cell comprises six coreless motors (anywhere between 4 mm to 10 mm diameter and 5 mm to 20 mm height) arranged in a 3×2 configuration with two columns and three rows. Each motor's shaft represents a single Braille dot, rotating to create a sensation at the position of Braille dot, thereby creating Braille characters (FIG. 1). The motors can be tilted at an angle such that the shafts provide greater contact surface to the touch (FIG. 2). The adjacent shafts can be rotated in opposite directions (clockwise and anti-clockwise) to enhance accuracy (FIG. 2). Additionally, the shafts can be coated with materials that provide friction with the touch surface of finger to improve recognition of moving shafts. One such material is silicone that can be coated onto the shafts pretreated with chemicals that lead to bonding between silicone and steel (e.g., IMB adhesives from Lord). Shafts can also be pitted, made rough, or attached to another element that spins along with shaft to improve recognition.

The distance between the motor shafts can be optimized for individual user preferences and touch sensitivity. Data was generated after separating the shafts 4 mm to 6 mm apart. The data shows that increasing the distance between the shafts leads to better recognition (spatially as well as the total number of moving shafts) when they are further apart. In another example, vibrating motors can be used to generate the vibration pattern. Each motor can be isolated so that vibration from one motor does not interfere with the vibration of a different motor. The rotation speed of the motor can also be optimized for optimal sensation and accuracy.

The display can be extended from a traditional 2×3 Braille cell pattern, to display images, lines, or 2D patterns. This can enhance the learning of visually impaired. Visually impaired individuals can place their whole hand to feel the lines or images that are displayed by this device.

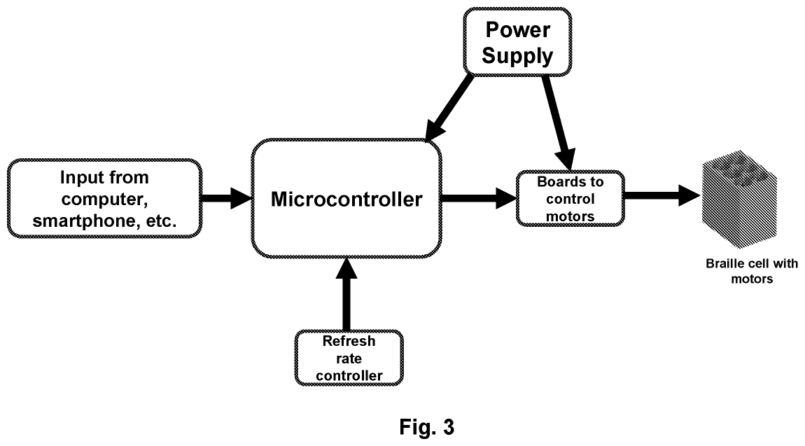

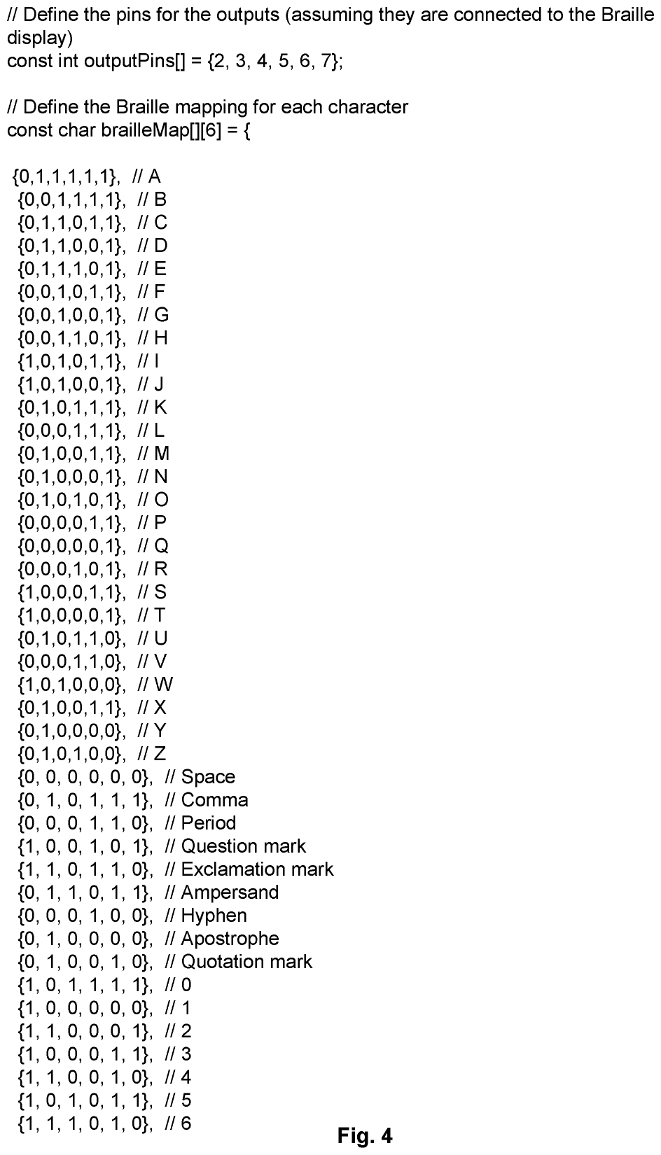

The motors are connected to a programmable microcontroller (e.g., Arduino Uno, Raspberry pi) via a motor driver (FIG. 3). The microcontroller is programmed such that it receives text data from a computer or smartphone or other electronic means to turn on or off the motors, driving individual motors to correspond to the desired Braille pattern. The refresh rate between characters on the Braille cell can be adjusted either via a voice input that provides microphone signal to the microcontroller or via a sensor (e.g., a pressure sensor that increases or decreases refresh rate based on pressure applied by another finger). Another way to change the refresh rate is through a potentiometer in which that user can turn the potentiometer to increase or reduce the refresh rate (FIG. 3). The data from other devices (e.g., computer or smartphone can be transmitted via a cable, Bluetooth, or Wi-Fi (FIG. 3).

An average braille reading speed is about 7.5 characters per second. This translates to about 130 ms refreshable rate. When the ends of motor shafts were 4 mm apart, refreshable rates as fast as 50 ms led to fairly accurate recognition (>90% accuracy).

These coreless motors have low power consumption. During their operation, the power consumption per motor was less than 300 mwatts. Compared to traditional displays, the use of coreless motors significantly reduces the overall cost of the device, making it more accessible to users. Unlike electromechanical modules used in conventional displays, coreless motors exhibit greater durability and are less prone to breakdowns. The sensation produced via rotation of motor shafts delivers faster response times compared to electromagnet-based methods.

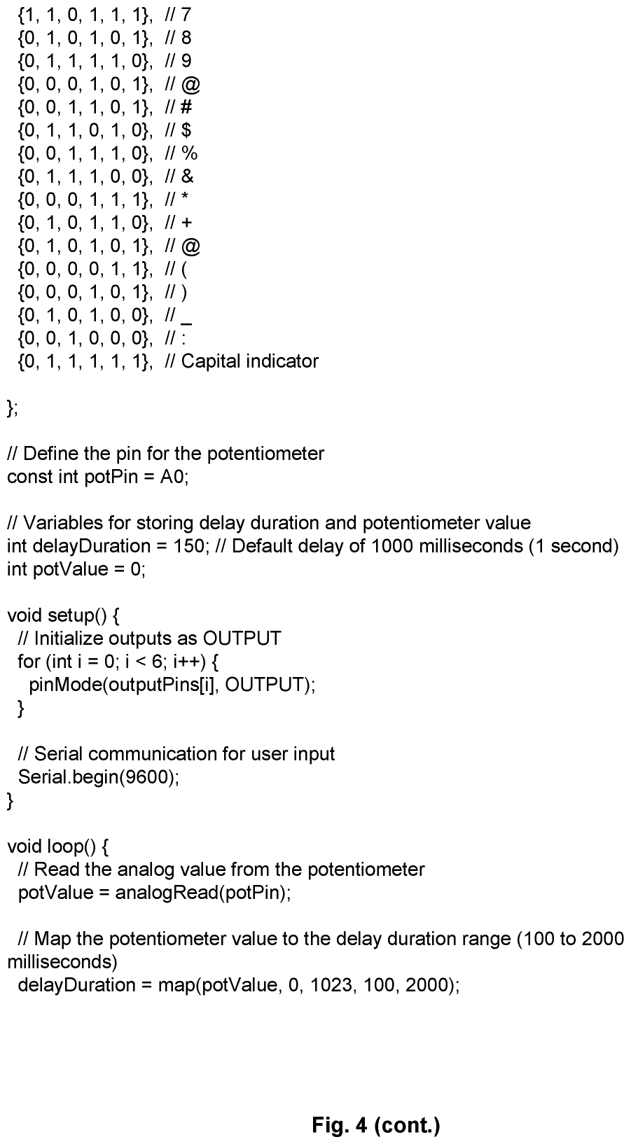

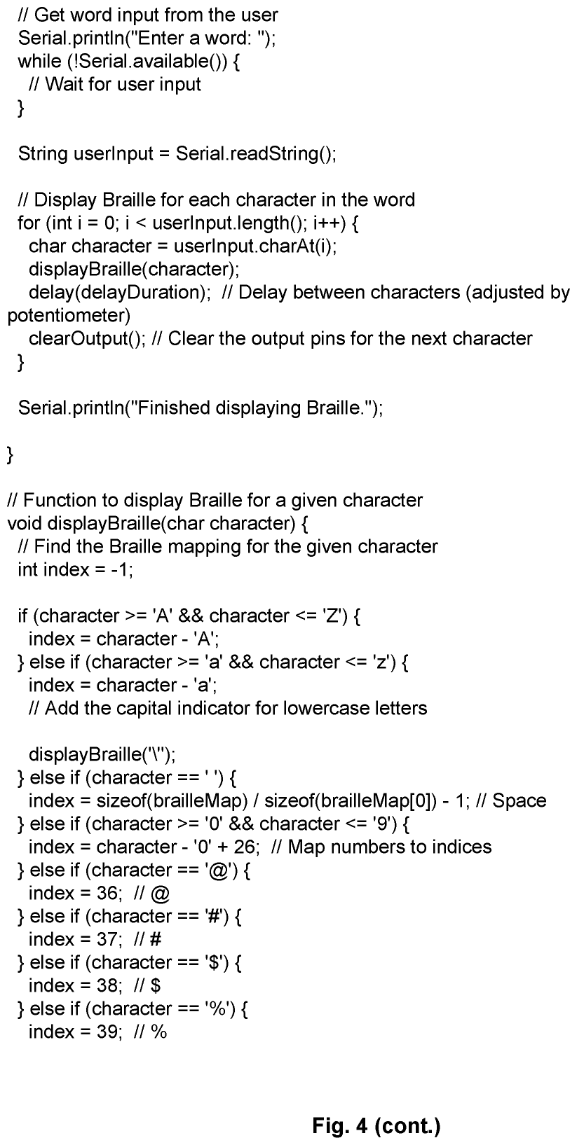

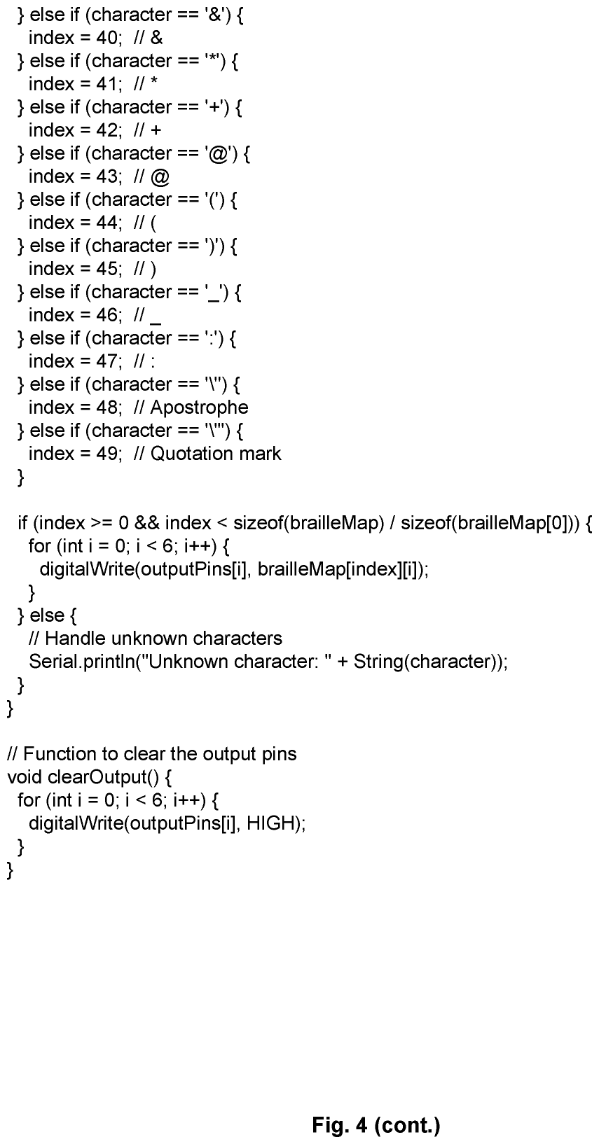

The controller can be programmed using a range of languages, including C, C++, Python, Assembly, Arduino (a simplified form of C++), and CircuitPython. In one embodiment, the program is developed using Arduino (as illustrated in FIG. 4). This program activates specific outputs on the microcontroller based on the letter that needs to be displayed. The output from the microcontroller then triggers a particular motor via the connected motor driver board. For example, if the letter ‘A’ is to be displayed, the output associated with the top left motor position is activated. However, if the letter ‘G’ is to be displayed, the outputs associated with the top two motors and the middle two motors are activated. The user can adjust the refresh rate by rotating a potentiometer.

The present invention has been described herein with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth herein.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The foregoing is illustrative of the present invention and is not to be construed as limiting thereof. Although a few example embodiments of this invention have been described, those skilled in the art will readily appreciate that many modifications are possible in the example embodiments without materially departing from the teachings and advantages of this invention. Accordingly, all such modifications are intended to be included within the scope of this invention as defined in the claims. The invention is defined by the following claims, with equivalents of the claims to be included therein. At least one specification heading is required. Please delete this heading section if it is not applicable to your application. For more information regarding the headings of the specification, please see MPEP 608.01(a).

1. A Tactile display system, comprising: a plurality of small motors arranged in a 3×2 configuration, each motor's shaft representing a single Tactile dot and rotating to create a sensation at the position of the Tactile dot, thereby creating Braille characters.

2. The Tactile display system of claim 1, wherein the motors are tilted at an angle between 0 and 90 degrees such that the shafts provide a greater contact surface to the touch.

3. The Tactile display system of claim 1, wherein adjacent shafts are rotated in opposite directions to enhance accuracy.

4. The Tactile display system of claim 1, wherein the shafts are coated with materials that provide friction with the touch surface of a finger to improve recognition of moving shafts.

5. The Tactile display system of claim 1, wherein the distance between the motor shafts can be optimized for individual user preferences and touch sensitivity.

6. The Tactile display system of claim 1, wherein the rotation speed of the motor can be optimized for optimal sensation and accuracy.

7. The Tactile display system of claim 1, wherein the display can be extended from a traditional 2×3 Tactile cell pattern to display images, lines, or 2D patterns.

8. The Tactile display system of claim 1, wherein the motors are connected to a programmable microcontroller via a motor driver, the microcontroller being programmed to receive text data from a computer or smartphone or other electronic means to turn on or off the motors, driving individual motors to correspond to the desired Tactile pattern.

9. The Tactile display system of claim 1, wherein the refresh rate between characters on the Tactile cell can be adjusted either via a voice input that provides a microphone signal to the microcontroller or via a sensor that increases or decreases the refresh rate based on pressure applied by another finger.

10. The Tactile display system of claim 1, wherein the refresh rate can be adjusted through a resistance or capacitance change, allowing the user to increase or reduce the refresh rate.

11. The Tactile display system of claim 1, wherein the data from other devices can be transmitted via a cable, Bluetooth, or Wi-Fi.

12. The Tactile display system of claim 1, wherein each motor has power consumption between 0.01-0.8 watt, and the use of coreless motors significantly reduces the overall cost of the device, making it more accessible to users.

13. The Tactile display system of claim 1, wherein the controller can be programmed using a range of languages, including C, C++, Python, Assembly, Arduino, and CircuitPython to control the speed and direction of motors.

14. The Tactile display system of claim 1, wherein vibrating motors are used to generate a vibration pattern, each motor being isolated so that vibration from one motor does not interfere with the vibration of a different motor.

15. The Tactile display system of claim 14, wherein the refresh rate and the vibration intensity can be controlled.
